(19) United States
(12) Patent Application Publication
(10) Pub. No.: US 2026/0081424 A1
(43) Pub. Date: Mar. 19, 2026

(54) CONTROL OF A CONVERTER IN AN AC GRID SUPPLIED BY RENEWABLE ENERGY SOURCES

(71) Applicant: ABB Schweiz AG, Baden (CH)

(72) Inventors: Sami PETTERSSON, Dietikon (CH); Francisco Canales, Baden-Dättwill (CH)

(21) Appl. No.: 19/400,208

(22) Filed: Nov. 25, 2025

Related U.S. Application Data
(63) Continuation of application No. PCT/EP2023/064378, filed on May 3, 2023.

(51) Int. Cl. H02J 3/16; H02J 3/38

(52) U.S. Cl. CPC H02J 3/16; H02J 3/381; H02J 3/388; H02J 2101/20

(57) ABSTRACT

A method for controlling a converter supplying a load is described. The converter is connected to an alternating current (AC) grid supplied by at least one renewable energy source. The method comprises receiving a measured AC grid voltage measured in the AC grid and a measured load voltage measured at an output of the converter. The method further comprises determining a magnitude of a fundamental positive-sequence component of the measured AC grid voltage. The method additionally comprises determining a load voltage reference from the magnitude and from a nominal load voltage reference, wherein the load voltage reference decreases when the magnitude decreases. The method also comprises determining a voltage error by subtracting the measured load voltage from the load voltage reference. The method further comprises controlling an output power of the converter based on the voltage error.

### CROSS-REFERENCE TO RELATED APPLICATIONS

The present application is a continuation of, and claims priority to, International Patent Application No. PCT/EP2023/064378, filed on May 30, 2023, and titled “CONTROL OF A CONVERTER IN AN AC GRID SUPPLIED BY RENEWABLE ENERGY SOURCES”, which is hereby incorporated by reference in its entirety.

### TECHNICAL FIELD

The present disclosure relates to the field of electrical AC grids, which are operated without a stable connection to a largescale grid, such as island grids or microgrids. In particular, the present disclosure relates to a method, a computer program, a computer-readable medium and a controller for controlling a converter for a load connected to an AC grid supplied by at least one renewable energy source. Furthermore, the present disclosure relates to a system comprising such a renewable energy source, electrical AC grid and converter.

### BACKGROUND

With the help of renewable energy sources, such as wind and solar power, hydrogen production plants may be placed in remote, isolated areas without connection to the national power distribution grids. Since, in such case, there is no common voltage source, the wind and/or solar inverters are responsible for forming the grid and maintaining its voltage amplitude and frequency under different operating conditions. Thus, because the energy production of such microgrids is solely dependent on the environmental conditions, for example, solar irradiance and wind speed which may constantly vary, it may be necessary to match the energy consumption with the production to avoid grid voltage collapse.

Typically, load power regulation in island operation is achieved by controlling the magnitude and frequency of the grid voltage, in other words, the output voltage of the grid forming converter. However, this usually leads to grid voltage and frequency variations every time the environmental conditions change, which may be undesirable.

Mainly, such as in CN 110 299 722 A, load power regulation in such grids is focused on DC distribution and its challenges and problems because, for example, batteries, fuel cells, electrolysers, and photovoltaic arrays are either generating DC or behave as DC loads. Furthermore, a common assumption is that there is an unlimited energy source in the form of a largescale power distribution grid available in parallel to the renewable energy source.

Furthermore, conventionally, grid forming control is performed by grid voltage regulation on the side of the converters of the renewable energy sources. For example, U.S. Pat. No. 11,005,270 B2 proposes a grid forming control method for a group of solar inverters in island operation based on AC grid voltage regulation via a frequency-power characteristic curve.

### BRIEF DESCRIPTION

It is an objective of the present disclosure, to simplify the operation of island grids and/or microgrids supplied by renewable energy sources.

This objective of the present disclosure is achieved by the subject-matter of the independent claims. Further exemplary embodiments are evident from the dependent claims and the following description. The embodiments and features, if any, described in this specification that do not fall under the scope of the independent claim are to be interpreted as examples useful for understanding various embodiments of the present disclosure.

An aspect of the present disclosure relates to a method for controlling a converter supplying a load, which load is connected via the converter to an AC grid. The AC grid is supplied by at least one renewable energy source.

The converter may be adapted for converting an AC current from the grid into a DC current or an AC current supplied to the load. The converter may comprise thyristors and/or transistors for switching the current. The method may be performed by a controller of the converter.

In general, the load may be any device and/or system adapted for receiving a variable input power. For example, the load may be an electrolyser, in other words, a device adapted for generating hydrogen from water by electrolyse. As a further example, the load also may be a device and/or system, such as a datacentre, with internal batteries for balancing the variable input power.

The at least one renewable energy source may comprise photovoltaic panels, wind turbines or water turbines. Each renewable energy source may comprise a source converter supplying the grid with an AC current. The one or more source converters of the renewable energy source may be static converters, in other words, such a converter is controlled to supply all power generated by the at least one renewable energy source into the AC grid, in particular independently of the natural variations of renewable energy.

The AC grid may be a grid independent of largescale grids, also called microgrid, and/or may have floating voltage and/or power. The AC grid need not be single-phased, but may be a three-phase grid. Also, the converter supplying the load and/or the converter of the at least one renewable energy source may be a three-phase converter.

According to an embodiment of the present disclosure, the method comprises: receiving a measured AC grid voltage measured in the AC grid and a measured load voltage measured at an output of the converter. The controller may receive measurement signals from voltage sensors at the input and at the output of the converter and/or acquires AC grid voltage and load voltage measurements.

According to an embodiment of the present disclosure, the method further comprises: determining a magnitude of a fundamental positive-sequence component of the measured AC grid voltage, which may be seen as the basic and/or ground sinusoidal component of the measured AC grid voltage.

According to an embodiment of the present disclosure, the method further comprises: determining a load voltage reference from the magnitude and a nominal load voltage reference, wherein the load voltage reference decreases, when the magnitude decreases and/or the load voltage reference increases, when the magnitude increases. In such a way, the load voltage reference is based on the magnitude of the fundamental positive-sequence component of the measured AC grid voltage. In particular, from the magnitude, a scaling coefficient may be determined, which is multiplied with a nominal load voltage reference to calculate the load voltage reference.

According to an embodiment of the present disclosure, the method further comprises: determining a voltage error by subtracting the measured load voltage from the load voltage reference. The voltage error may be used as indicator, how much the input power from the AC grid deviates from a nominal input power.

According to an embodiment of the present disclosure, the method further comprises: controlling an output power of the converter with the voltage error. For example, firing angles of thyristors of the converter may be determined and moved based on the voltage error. Also, a duty cycle of the converter may be set based on the voltage error.

The method may be seen as a control method to regulate the power of devices, such as electrolysers, connected to AC microgrids that rely entirely on renewable energy sources. With the method, it is possible to enable load power regulation without any communication between the source converters of the renewable energy sources and the load converters by monitoring the AC grid voltage. The method is independent of converter topology and may be applied to a controller of any converter type that is adapted for reducing load power. With the method, the AC grid voltage magnitude and frequency variations are minimized as the load adapts itself according to the energy availability.

According to an embodiment of the present disclosure, the method further comprises: scaling the AC grid voltage, such that when the AC grid voltage is equal to a nominal voltage, the scaled AC grid voltage has a phase voltage peak of 1. The AC grid voltage is scaled such that the nominal phase voltage peak corresponds to a value of 1. In this way, the following method activities become independent of the nominal voltage.

According to an embodiment of the present disclosure, the method further comprises: transforming the (in some embodiments, scaled) AC grid voltage into a space vector having two components and extracting the fundamental positive-sequence component of the AC grid voltage from the space vector. The phase voltages of the AC grid voltages may be transformed with a Clarke transformation into a complex valued space vector. The fundamental positive-sequence component may be extracted easier from the space vector.

According to an embodiment of the present disclosure, the method further comprises: low pass filtering the magnitude of the fundamental positive-sequence component. To remove fast changes in AC grid voltage, which may be caused by fast changes of the renewable energy sources, the fundamental positive-sequence component may be low pass filtered. Here, the term “fast” may refer to a time scale that is filtered out by the corresponding low pass filter.

According to an embodiment of the invention present disclosure, the method further comprises: low pass filtering the measured load voltage. The measured load voltage may be low pass-filtered to remove fast changing power drains of the load. Here, again the term “fast” may refer to a time scale that is filtered out by the corresponding low pass filter.

According to an embodiment of the present disclosure, the method further comprises: applying a function to the magnitude of the fundamental positive-sequence component to determine an amplified magnitude, wherein the load voltage reference is determined from the amplified magnitude. The load voltage reference need not be proportional or linear-dependent on the magnitude. The function may be seen as a magnitude dependent amplification function, which is used to set the strength of control intervention in dependence of the magnitude.

The amplified magnitude may be a scaling coefficient and/or may be multiplied with the nominal voltage reference. The amplified magnitude is used to scale the nominal voltage reference to determine the load voltage reference.

According to an embodiment of the present disclosure, the function is a power function with an exponent between 1.5 and 3.5. For example, the exponent may be 2 or 3. The power function may be chosen based on a relationship between the load voltage and the load power. For example, an electrolyser is usually not a linear system, so its power reduction is not exactly inversely proportional to the voltage squared. In the case of an electrolyser system, a good performance may be achieved by setting the power at 3. In any case, the power function may be chosen based on a load model to reach optimal performance with specific loads.

According to an embodiment of the present disclosure, the method further comprises: restricting the amplified magnitude between 0 and 1. This is to ensure that the load voltage reference stays within 0 and the nominal voltage reference.

According to an embodiment of the present disclosure, the method further comprises: determining a control variable from the voltage error by applying a PI controller to the voltage error. For example, the control variable may be used for controlling a duty cycle of the load converter. For example, the control variable may be a duty cycle reference of the load converter or the firing angle of a thyristor rectifier. In particular, the final firing angle of a thyristor rectifier may be determined from the control variable.

According to an embodiment of the invention present disclosure, the AC grid is solely supplied by the at least one renewable energy source. A maximal power generated by at least one renewable energy source is less than 10 MW, in other words, the system comprising the AC grid may be a low scale or medium scale system. The grid may be seen as an island grid. As already mentioned, the AC grid may be disconnected from largescale grids stabilizing voltage, power, phase angle and/or frequency.

According to an embodiment of the present disclosure, the load is an electrolyser. In particular, the hydrogen generation of electrolysers easily may be set dependent on the available power.

According to an embodiment of the present disclosure, the converter is an active rectifier and the measured load voltage is a DC voltage. The load may be a DC load. In the case of an AC load, the measured load voltage may be a DC link voltage of a DC link between a load rectifier and a load inverter.

A further aspect of the present disclosure relates to a method for controlling a power supplied to at least two loads connected to an AC grid supplied by at least one renewable energy source. Each of the loads is controlled with the method as described herein. Furthermore, the loads may be controlled independently from each other. This may mean that the power control of one load does not depend on control variables determined for another load. In particular, multiple paralleled load converters, which may be connected to the same point of common coupling, may be controlled with the method without any additional control parameter tuning.

Further aspects of the present disclosure relate to a computer program, which, when being executed by a processor, is adapted for performing the method as described herein, as well as to a computer-readable medium, in which such a computer program is stored. The computer program may be part of control software of a controller of the load converter.

A computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, for example, the Internet, which allows downloading a program code. In general, the computer-readable medium may be a non-transitory or transitory medium.

A further aspect of the present disclosure relates to a controller for controlling a power supplied via a converter to a load, which controller is adapted for performing the method as described herein. It has to be noted that the method also may be implemented at least partially in hardware, for example in a DSP or FPGA.

A further aspect of the present disclosure relates to an electrical system, which comprises at least one renewable energy source; a load; a converter suppling the load; an AC grid interconnecting the at least one renewable energy source via the converter with the load and a controller for controlling the converter, such as described herein.

It has to be understood that features of the method as described in the above and in the following may be features of the system as described in the above and in the following, and vice versa.

These and other aspects of the present disclosure will be apparent from and elucidated with reference to the embodiments described hereinafter.

### BRIEF DESCRIPTION OF DRAWINGS

The subject-matter of the present disclosure will be explained in more detail in the following text with reference to exemplary embodiments which are illustrated in the attached drawings.

FIG. 1 schematically shows an electrical system according to an embodiment of the present disclosure.

FIG. 2 shows a block diagram illustrating a method and controller according to an embodiment of the present disclosure.

FIGS. 3 and 4 schematically show electrical systems according to further embodiments of the present disclosure.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can be applied to a corresponding part or aspect in another embodiment as well.

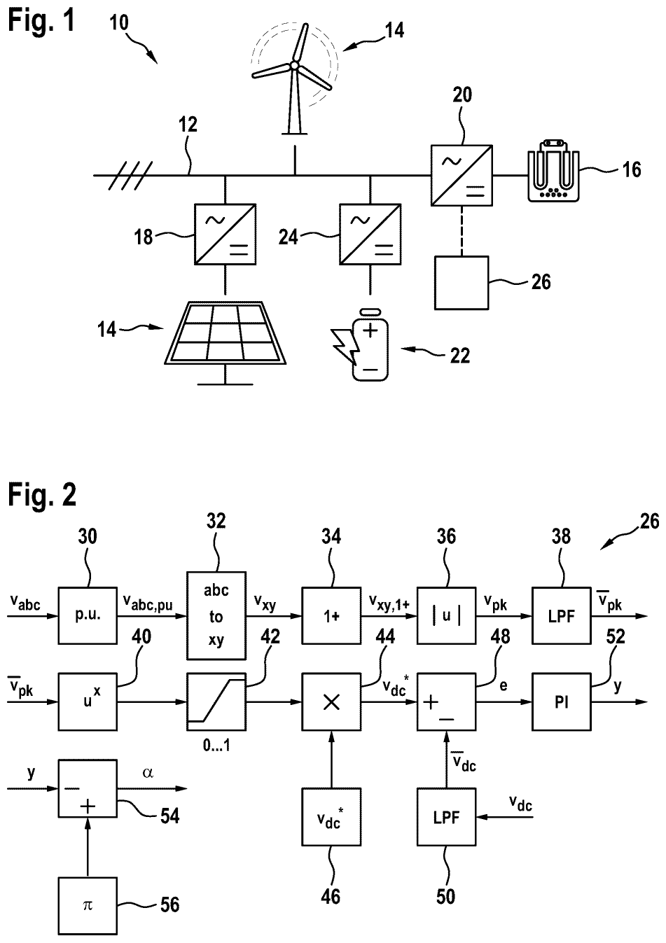

FIG. 1 shows an electrical system 10, which comprises an AC grid 12, renewable energy sources 14 and a load 16 in the form of a hydrogen electrolyser.

The renewable energy sources 14 comprise source converters 18, which supply the AC grid with an AC current. The load 16 comprises a load converter 20, which draws power from the AC grid and supplies the load 16 with power.

As shown, the AC grid 12 may be a three-phase grid and the converters 18, 20 may be three-phase converters. The AC grid 12 may be a microgrid, in other words, may be disconnected from largescale distribution grids, which may be used for stabilizing power and frequency in the AC grid 12.

Furthermore, a battery system 22 may be connected to the AC grid, for example via a further converter 24. The battery system 22 may be used to balance a power in the AC grid. However, when the batteries of the battery system 22 are empty or full, such a balancing may not be possible.

FIG. 1 also shows a controller 26 of the load converter 20, which controls the load converter 20 to reduce its output power to the load 16, when the voltage in the grid decreases.

FIG. 2 shows a block diagram of the controller 26, which also describes the method performed by the controller 26.

With the method, the power supplied to the load 16, such as an electrolyser, is regulated. The load 16 is connected to the AC grid 12, which may rely entirely on renewable energy sources 14, such as solar or wind power sources. In the AC grid 12, the AC grid voltage may be formed by static converters 18 alone, and the amount of energy available is fully dependent on environmental conditions, such as solar irradiance and/or wind speed which may be constantly changing.

With the method, the load power may be regulated to match the power available by controlling the operating point of the load converter 20, in particular without communication link between the one or more source converters 18 and the load converter 20. This approach removes or at least reduces grid voltage and frequency variations due to changing environmental conditions and therefore may keep the AC grid 12 always more stable.

The method is not converter topology specific and can therefore be used with any type of converter 20 that can lower the load power. The converter 20 may be a thyristor rectifier, a diode and active voltage-source rectifier, in some embodiments, with a buck-type DC-DC converter as second conversion stage, a pulse width modulated current-source rectifier, a diode rectifier fed by a transformer equipped with remotely adjustable tap changer, etc. In particular, a traditional 12-pulse thyristor rectifier may be used and in the following sometimes it is referred to such a converter as an example.

In block 30, a measured AC grid voltage v_{abc} is received, which has been measured in the AC grid 12, for example at a point of connection and/or at an input of the converter 20 to the grid 12. In the case of a three-phase grid 12, it may be enough to measure solely two line-to-line voltages of the AC grid 12, which may be converted to three-phase voltages.

The AC grid voltage v_{abc} is scaled, such that, when the AC grid voltage v_{abc} is equal to a nominal voltage, the scaled AC grid voltage v_{abc,pu} has a phase voltage peak of 1. The three-phase voltages v_{abc} are scaled to per unit values (p.u.) such that the nominal phase voltage peak corresponds to a value of scaled AC grid voltage v_{abc,pu}.

In block 32, the scaled AC grid voltage v_{abc,pu} is transformed into a space vector v_{xy} having two components. The space vector v_{xy} is in the stationary reference frame and may be generated using the standard Clarke transformation (abc to xy).

In block 34, the fundamental positive-sequence component v_{xy,1+} of the AC grid voltage v_{abc} is extracted from the space vector v_{xy}. This is done to avoid effects of voltage harmonics and phase imbalance in the load voltage reference v_{dc}* (see below).

In block 36, a magnitude vₚₖ of a fundamental positive-sequence component v_{xy,1+} of the measured AC grid voltage v_{abc} is determined, such as depicted by |u|. The magnitude vₚₖ is thus used as the monitored quantity.

In block 38, the magnitude vₚₖ of the fundamental positive-sequence component v_{xy,1+} is filtered. This filtering may include low pass filtering (LPF), periodic averaging, and/or moving averaging.

In blocks 40 to 46, the load voltage reference v_{dc}* is generated based on the magnitude vₚₖ or filtered magnitude v̅ₚₖ of the fundamental positive-sequence component v_{xy,1+}.

In block 40, a function is applied to the magnitude vₚₖ or filtered magnitude v̅ₚₖ of the fundamental positive-sequence component v_{xy,1+} to determine an amplified magnitude.

The function defines how rapidly the load voltage reference v_{dc}* decreases when the AC grid voltage v_{abc} drops below its nominal value. For example, the function is a power function u^{x} with an exponent between 1.5 and 3.5. A good performance can be achieved by setting the exponent x to 2 or 3.

In block 42, the amplified magnitude is restricted between 0 and 1. The output of block 42 is a scaling coefficient for the load voltage v_{dc}* and is limited between values of 0 and 1.

In block 44, the instantaneous load voltage reference v_{dc}* is determined from restricted scaling coefficient, which is multiplied with a nominal load voltage reference V_{dc}, which is provided by block 46.

In block 48, a voltage error e is determined by subtracting a measured and in some embodiments, filtered load voltage v_{dc} from the load voltage reference v_{dc}*.

Block 50 receives the measured load voltage v_{dc}, which has been measured at an output of the converter 20. In some embodiments, the measured load voltage v_{dc} may be low pass-filtered (LPF) into a filtered load voltage v̅_{dc} to reduce unwanted oscillations and noise.

In block 52, a control variable y is determined from the voltage error e by applying a PI controller to the voltage error e. The voltage controller may be a standard PI controller, which outputs the control variable y. The control variable y may be the duty cycle reference of the converter 20 and/or the control variable y may control a duty cycle of the converter 20.

As shown in block 54, in the case of a thyristor rectifier, the control variable y may be used to determine the firing angle α of the thyristors. Since a larger firing angle α reduces the load voltage of a thyristor rectifier, the angle is inverted by subtracting the control variable from 180° (provided by block 56) to obtain the firing angle α.

In the end, the converter 20 is controlled with the control variable y, specifically with the firing angle α, by generating corresponding switching signals and applying them to the semiconductor switches of the converter 20.

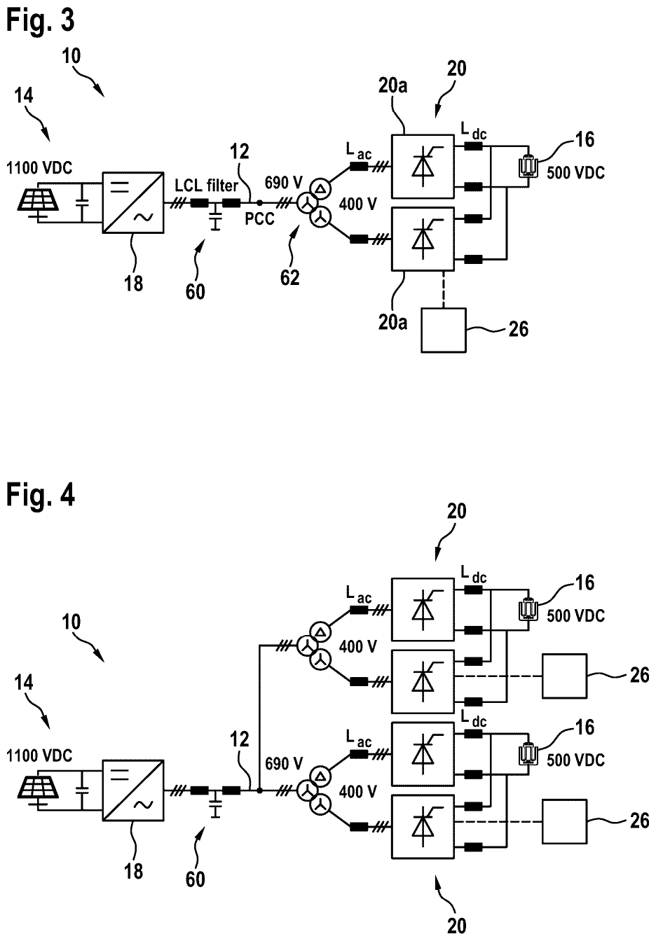

FIG. 3 shows an embodiment of a system 10, where the renewable energy source 14 comprises a 1 MVA solar inverter 18 feeding a 12-pulse thyristor rectifier 20 with electrolyser as load 16. A photovoltaic array with an open-circuit voltage of ca. 1200 V is connected to the DC input of the solar inverter 18. The solar inverter 18 operates in grid-forming mode and generates a three-phase 50 Hz grid voltage with 690 V line-to-line rms voltage at the output of an LCL type supply filter 60. The 12-pulse thyristor rectifier 20 is connected to a point of common coupling PCC through a wye-delta-wye transformer 62, which activities down the 690 V primary side voltage to 400 V on the secondary side. Each rectifier bridge 20a, 20b has a three-phase filter inductor on the ac side (L_{ac}) and DC inductors at both terminal on the dc side (L_{dc}). The individual rectifier bridge DC terminals are paralleled, and the electrolyser 16 is connected between the common positive and negative rail of the rectifier 20.

During steady-state operation at 100 % solar irradiance and nominal load of 1 MW, the DC input voltage of the solar inverter 18 is ca. 1100 V, which is adequate for the inverter 18 to maintain the nominal grid voltage. When the irradiance suddenly drops down to 25% while the load power remains the same, the direct voltage of the inverter 18 starts dropping. The controller of the solar inverter 18 tries to always keep the magnitude and frequency of the voltage at the PCC constant, but this is only possible, if the voltage of the solar array 14 stays higher than the peak of the generated line-to-line voltage. At some point, the direct voltage becomes too low, and the grid voltage amplitude must be therefore reduced. This is detected by the controller 26 of the load converter 20, which begins increasing the firing angle α and reducing the load power to prevent grid voltage collapse.

FIG. 4 shows an embodiment of a system 10 comprising two loads 16, each of which is connected via a load converter 20 with the AC grid 12. Each of the loads 16 are designed like the load shown in FIG. 3 and is connected to the point of common coupling PCC.

The power provided by the solar inverter 18 is now shared by the two 12-pulse thyristor rectifiers 20 with individual controllers 26, which are operated independently from each other. There is no inter-unit communication between the converters 20 and their controllers 26. Each controller 26 performs the control method independently.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for controlling a converter supplying a load, wherein the converter is connected to an alternating current (AC) grid supplied by at least one renewable energy source, the method comprising:
receiving a measured AC grid voltage measured in the AC grid and a measured load voltage measured at an output of the converter;
determining a magnitude of a fundamental positive-sequence component of the measured AC grid voltage;
determining a load voltage reference from the magnitude and from a nominal load voltage reference, wherein the load voltage reference decreases when the magnitude decreases;
determining a voltage error by subtracting the measured load voltage from the load voltage reference; and
controlling an output power of the converter based on the voltage error.

2. The method of claim 1, further comprising:
scaling the AC grid voltage such that when the AC grid voltage is equal to a nominal voltage, the scaled AC grid voltage has a phase voltage peak of 1.

3. The method of claim 1, further comprising:
transforming the AC grid voltage into a space vector having two components; and
extracting the fundamental positive-sequence component of the AC grid voltage from the space vector.

4. The method of claim 1, further comprising:
low pass filtering the magnitude of the fundamental positive-sequence component; and/or
low pass filtering the measured load voltage.

5. The method of claim 1, further comprising:
applying a function to the magnitude of the fundamental positive-sequence component to determine an amplified magnitude, wherein the load voltage reference is determined from the amplified magnitude.

6. The method of claim 5, wherein the function is a power function with an exponent between 1.5 and 3.5.

7. The method of claim 5, further comprising:
restricting the amplified magnitude between 0 and 1.

8. The method of claim 1, further comprising:
determining a control variable from the voltage error by applying a PI controller to the voltage error and controlling the converter with the control variable, wherein the control variable controls a duty cycle of the converter.

9. The method of claim 1, wherein:
the AC grid is solely supplied by the at least one renewable energy source; and/or
a maximal power generated by the at least one renewable energy source is less than 10 MW; and/or
the AC grid is an island grid.

10. The method of one claim 1, wherein:
the load is an electrolyser; and/or
the converter is an active rectifier and the measured load voltage is a DC voltage.

11. The method of claim 1, wherein:
the converter supplies power to at least two loads connected to the AC grid, and
each of the loads is controlled independently from each other.

12-14. (canceled)

15. An electrical system, comprising:
at least one renewable energy source;
a converter for suppling a load;
an alternating current (AC) grid interconnecting the at least one renewable energy source with the converter; and
a controller configured to:
receive a measured AC grid voltage measured in the AC grid and a measured load voltage measured at an output of the converter;
determine a magnitude of a fundamental positive-sequence component of the measured AC grid voltage;
determine a load voltage reference from the magnitude and from a nominal load voltage reference, wherein the load voltage reference decreases when the magnitude decreases;
determine a voltage error by subtracting the measured load voltage from the load voltage reference; and
control an output power of the converter based on the voltage error.

16. The electrical system of claim 15, wherein the controller is further configured to:
scale the AC grid voltage, such that when the AC grid voltage is equal to a nominal voltage, the scaled AC grid voltage has a phase voltage peak of 1.

17. The electrical system of claim 15, wherein the controller is further configured to:
transform the AC grid voltage into a space vector having two components; and
extract the fundamental positive-sequence component of the AC grid voltage from the space vector.

18. The electrical system of claim 15, wherein the controller is further configured to:
low pass filter the magnitude of the fundamental positive-sequence component; and/or
low pass filter the measured load voltage.

19. The electrical system of claim 15, wherein the controller is further configured to:
apply a function to the magnitude of the fundamental positive-sequence component to determine an amplified magnitude, wherein the load voltage reference is determined from the amplified magnitude.

20. A non-transitory computer-readable medium embodying programmed instructions which, when executed by at least one processor of a converter supplying a load, wherein the converter is connected to an alternating current (AC) grid supplied by at least one renewable energy source, cause the at least one processor to:
receive a measured AC grid voltage measured in the AC grid and a measured load voltage measured at an output of the converter;
determine a magnitude of a fundamental positive-sequence component of the measured AC grid voltage;
determine a load voltage reference from the magnitude and from a nominal load voltage reference, wherein the load voltage reference decreases when the magnitude decreases;
determine a voltage error by subtracting the measured load voltage from the load voltage reference; and
control an output power of the converter based on the voltage error.

21. The non-transitory computer-readable medium of claim 20, wherein the programmed instructions further cause the at least one processor to:
scale the AC grid voltage, such that when the AC grid voltage is equal to a nominal voltage, the scaled AC grid voltage has a phase voltage peak of 1.

22. The non-transitory computer-readable medium of claim 20, wherein the programmed instructions further cause the at least one processor to:
transform the AC grid voltage into a space vector having two components; and
extract the fundamental positive-sequence component of the AC grid voltage from the space vector.

23. The non-transitory computer-readable medium of claim 20, wherein the programmed instructions further cause the at least one processor to:
low pass filter the magnitude of the fundamental positive-sequence component; and/or
low pass filter the measured load voltage.
